(19) United States
(12) Patent Application Publication
(10) Pub. No.: US 2013/0103342 A1
(43) Pub. Date: Apr. 25, 2013

(54) Method of Measuring Fictive Temperature of Optical Glass

(71) Applicants: Junichi Kushibiki, Miyagi (JP); Mototaka Arakawa, Miyagi (JP)

(72) Inventors: Junichi Kushibiki, Miyagi (JP); Mototaka Arakawa, Miyagi (JP)

(73) Assignees: Touhoku Techno Arch Co., Ltd., Miyaga (JP); Chuo Precision Industrial Co. Ltd., Tokyo (JP)

(21) Appl. No.: 13/805,339

(22) PCT Filed: Jun. 30, 2011
(86) PCT No.: PCT/JP2011/065053

§ 371 Date: Dec. 18, 2012

(30) Foreign Application Priority Data
Jun. 30, 2010 (JP) 2010-149961

(51) Int. Cl. G01N 25/00

(52) U.S. Cl. CPC G01N 25/00
USPC 702/136

(57) ABSTRACT

A heat treatment is performed at different temperatures for a plurality of calibration-line forming optical glass samples that can be considered as having the same composition as optical glass to be measured, any one of the longitudinal wave velocity, the LSAW velocity and the shear wave velocity of the samples is measured as an acoustic property AP₁, and a relationship between the fictive temperature T_{f} and the acoustic property AP₁ is determined in the form of approximate straight line formula on the assumption that the heat treatment temperature is regarded as the fictive temperature T_{f} in a range where the heat treatment temperature and the acoustic property AP₁ are in a linear relationship. The acoustic property AP₁ of the optical glass to be measured is measured, and the fictive temperature is calculated from the measured acoustic property AP₁ according to the approximate straight line formula.

### TECHNICAL FIELD

The present invention relates to glass used in optical applications, such as a lens, a prism and a photomask. In particular, it relates to a method of measuring the fictive temperature that has an effect on the refractive index, the transmittance, the resistance to ultraviolet rays and the expansion coefficient of optical glass.

### BACKGROUND ART

For example, silica glass has three major advantages of an extremely high transmittance, a high heat resistance and an extremely low metal impurity content and is an indispensable material for semiconductor devices and optical communication cables. Besides, silica-titania (TiO₂—SiO₂) glass is drawing attention as ultra-low expansion glass used as a substrate material of photomask blanks and reflective optics for extreme ultraviolet lithography (EUVL) systems. The silica glass is generally classified into two types: fused silica glass fabricated by melting a natural crystal powder, and synthetic glass fabricated by chemical synthesis. The fused silica glass can be fabricated in an electric melting method (Type I) that involves electrically melting the natural crystal powder or in a flame melting method (Type II) that involves melting the natural crystal powder in oxyhydrogen flame. The synthetic silica glass can be fabricated by a direct method (Type III) that involves directly depositing fine particles of silica glass by hydrolysis of silicon tetrachloride (SiCl₄), octamethylcyclotetrasiloxane (C₈H₂₄O₄Si₄) or the like in oxyhydrogen flame, a plasma method (Type IV) that uses induced plasma of Ar or O₂ instead of the oxyhydrogen flame for synthesis, a soot method that involves producing a lump of soot of silica by thermal decomposition of silicon tetrachloride (SiCl₄) or the like and then burning the lump of soot, or a sol-gel method that involves producing a gel by hydrolysis and condensation polymerization in a solution containing silicon alkoxide, such as Si(OC₂H₅)₄, water, an alcohol and hydrochloric acid, drying the gel and then heating the gel to cause vitrification.

The synthetic silica glass, which has a low metal impurity content of 10 ppb or less, is used in optical applications, such as a lens, a prism and a photo mask. In general, the optical applications require glass that has a high uniformity of the refractive index and a high transmittance and is free of defects which cause light scattering. Glass used for a lens of a reduction projection exposure system (a stepper) is additionally required to have a high resistance to ultraviolet rays, that is, to be less likely to change in refractive index and decrease in transmittance when the glass is irradiated with ultraviolet rays. The refractive index, the transmittance and the resistance to ultraviolet rays of the synthetic silica glass and the silica-titania glass vary with the concentrations of hydroxyl (OH) and other impurities, or F and Ti as additives added to the glasses in the production process. The concentration of OH trapped in the production process is typically 500 to 2000 [wtppm] for the synthetic silica glass fabricated in the direct method (Type III) and 50 to 200 [wtppm] for the synthetic silica glass fabricated by a vapor-phase axial deposition (VAD) method, which is a kind of soot method, so that it is essential not only to control the concentration of the additives but also to control the OH concentration and other impurities during production.

It is also known that the refractive index, the transmittance and the resistance to ultraviolet rays of the synthetic silica glass are substantially affected by the fictive temperature of the silica glass. Similarly, the temperature at which the expansion coefficient of the silica-titania glass is 0 is also affected by the fictive temperature. Therefore, just controlling the concentrations of the additives and the impurities is not enough, and the fictive temperature needs to be controlled and evaluated. Thus, there is a demand for a method of precisely measuring the fictive temperature that can be introduced into a manufacturing line.

Known methods of measuring the fictive temperature include a method based on the Raman spectroscopic analysis and a method based on the infrared spectroscopic analysis. Non-patent literature 1 discloses a well-known method of measuring the fictive temperature based on the infrared spectroscopic analysis. Non-patent literature 2 discloses a well-known method of measuring the fictive temperature based on the Raman spectroscopic analysis.

Furthermore, as reported in Non-patent literatures 3 and 5, there are known methods of determining the fictive temperature from measurement values of the density of the synthetic silica glass according to the relationship between the density and the fictive temperature.

However, all the conventional fictive temperature measuring methods described above have the following disadvantages:

(1) the measurement precision of the fictive temperature is inadequate, ±15° C. for the infrared spectroscopic analysis and about ±60° C. for the Raman spectroscopic analysis;
(2) the methods need a sample used for measurement of the fictive temperature separately prepared and thus are difficult to introduce into the manufacturing line;
(3) the methods can hardly measure the fictive temperature distribution over the substrate surface; and
(4) the methods yield only the average value for the sample in the case of the density-based fictive temperature evaluation.

Furthermore, the present inventors have already investigated the relationship between the density of the synthetic silica glass and the longitudinal wave velocity, found that there is a linear relationship between them, and reported in Non-patent literature 4 that there is a linear relationship between the longitudinal wave velocity and the fictive temperature determined from the density according to the relationship between the fictive temperature and the density reported in Non-patent literature 3.

In Non-patent literature 3, it is reported that the slope of the dependence of the density on the fictive temperature varies with the chlorine concentration. On the other hand, in Non-patent literature 5, it is reported that the slope of the dependence of the density on the fictive temperature does not vary with the OH concentration. Further investigation has shown that the relationship between the fictive temperature and the density varies in coefficient with the OH concentration of the silica glass, and it is difficult to incorporate density measurement into the manufacturing line. Thus, the present invention has been devised.

### PRIOR ART LITERATURE

### Non-Patent Literature

Non-patent literature 1: A. Agarwal, K. M. Davis, and M. Tomozawa, “A simple IR spectroscopic method for determining fictive temperature of silica glasses,” J. Non-Cryst. Solids, Vol. 185, pp. 191-198 (1995).
Non-patent literature 2: A. E. Geissberger and F. L. Galeener, “Raman studies of vitreous SiO₂ versus fictive temperature,” Phys. Rev. B, Vol. 28, pp. 3266-3271 (1983).
Non-patent literature 3: H. Kakiuchida, E. H. Sekiya, N. Shimodaira, K. Saito, and A. J. Ikushima, “Refractive index and density changes in silica glass by halogen doping,” J. Non-Cryst. Solids, Vol. 353, pp. 568-572 (2007).
Non-patent literature 4: Arakawa, Shimamura and Kushibiki, “Evaluation of synthetic silica glass by the ultrasonic microspectroscopy technology”, IEICE Technical Report Vol. US2008-34, pp. 13-18 (2008.9)
Non-patent literature 5: J. E. Shelby, “Density of vitreous silica,” J. Non-Cryst. Solids, Vol. 349, pp. 331-336 (2004).

### SUMMARY OF THE INVENTION

### Problems to be Solved by the Invention

An object of the present invention is to overcome the disadvantages of conventional methods of measuring the fictive temperature of optical glass and to provide a method of measuring the fictive temperature of optical glass with higher precision than conventional.

### Means to Solve the Problems

A method of measuring a fictive temperature of optical glass according to a first aspect of the present invention comprises:

(1-A) a step of performing a heat treatment at different temperatures for a plurality of calibration-line forming glass samples having a same composition;

(1-B) a step of measuring any one of a longitudinal wave velocity, an leaky surface acoustic wave (LSAW) velocity and a shear wave velocity of the samples obtained in said step (1-A) as an acoustic property AP₁;

(1-C) a step of determining an approximate straight line formula:

T_{f}=a×AP₁+b

that expresses a relationship between a fictive temperature and the acoustic property AP₁ measured in said step (1-B) on an assumption that said heat treatment temperature is the fictive temperature, provided that T_{f} denotes the fictive temperature, and a and b denote constant; and

(1-D) a step of measuring the acoustic property AP₁ of an optical glass sample to be measured having the same composition as said calibration-line forming glass samples and determining the fictive temperature T_{f} by calculation according to said approximate straight line formula.

A method of measuring a fictive temperature of optical glass according to a second aspect of the present invention comprises:

(2-A) a step of performing a heat treatment at different temperatures for a plurality of calibration-line forming glass samples having a same composition;

(2-B) a step of measuring any one of a longitudinal wave velocity, an LSAW velocity and a shear wave velocity of the samples obtained in said step (2-A) as a first acoustic property AP₁ and another of the velocities as a second acoustic property AP₂;

(2-C) a step of determining a first approximate straight line formula:

T_{f}=a×AP₁+b

that approximates a relationship between a fictive temperature and said first acoustic property AP₁ on an assumption that said heat treatment temperature is the fictive temperature, provided that T_{f} denotes the fictive temperature, and a and b denote constants;

(2-D) a step of determining a second approximate straight line formula:

T_{f}=c×AP₂+d

that expresses a relationship between the fictive temperature T_{f} determined in said step (2-C) and said second acoustic property AP₂, provided that c and d denote constants; and

(2-E) a step of measuring the second acoustic property AP₂ of an optical glass sample to be measured having the same composition as said calibration-line forming glass samples and determining the fictive temperature T_{f} from the measured second acoustic property AP₂ according to said second approximate straight line formula.

### Effects of the Invention

The present invention provides a method of measuring the fictive temperature of optical glass that can measure the fictive temperature with higher precision than conventional methods of measuring the fictive temperature by one or more orders of magnitude, can measure the fictive temperature of the material in the production line, and can measure the in-plane distribution of the fictive temperature of the sample to be measured.

Of course, the basic principle of the “method of measuring the fictive temperature” according to the present invention can be applied not only to the synthetic silica but also to synthetic silica glass with the properties improved by an appropriate additive (fluorine, germanium, phosphorus, boron or the like), synthetic silica glass containing residual impurities (OH, chlorine or the like), fused silica glass, TiO₂—SiO₂ glass which is ultra-low expansion glass, and other popular glass materials (such as borosilicate glass and soda lime glass).

### BRIEF DESCRIPTION OF THE DRAWINGS

FIG. 1 is a diagram showing Table 1 showing the OH concentration, the strain point, the annealing point and the fabricating method of synthetic silica glass samples;

FIG. 2A is a graph showing a relationship between the heat treatment temperature and the longitudinal wave velocity of synthetic silica glass samples #1 and #2;

FIG. 2B is a graph showing a relationship between the heat treatment temperature and the LSAW velocity of synthetic silica glass samples #1 and #2;

FIG. 2C is a graph showing a relationship between the heat treatment temperature and the shear wave velocity of synthetic silica glass samples #1 and #2;

FIG. 2D is a graph showing a relationship between the heat treatment temperature and the density of synthetic silica glass samples #1 and #2;

FIG. 3 is a graph showing a relationship between the longitudinal wave velocity and the density of the synthetic silica glass samples #1 and #2;

FIG. 4A is a graph showing a relationship between the fictive temperature and the longitudinal wave velocity of synthetic silica glass samples #1 and #2;

FIG. 4B is a graph showing a relationship between the fictive temperature and the LSAW velocity of synthetic silica glass samples #1 and #2;

FIG. 4C is a graph showing a relationship between the fictive temperature and the shear wave velocity of synthetic silica glass samples #1 and #2;

FIG. 4D is a graph showing the fictive temperature and the density of synthetic silica glass samples #1 and #2;

FIG. 5 is a diagram showing Table 2 showing the sensitivity and the resolution of the acoustic properties of the synthetic silica glass samples #1 and #2 to the fictive temperature;

FIG. 6 is a graph showing a relationship between the heat treatment temperature and the longitudinal wave velocity of silica-titania glass; and

FIG. 7 is a flowchart showing a procedure of determining the fictive temperature of optical glass according to the present invention.

### DETAILED DESCRIPTION OF THE EMBODIMENTS

### Example

### Preparation

In the following, measurement of the fictive temperature of synthetic silica glass as optical glass will be first described.

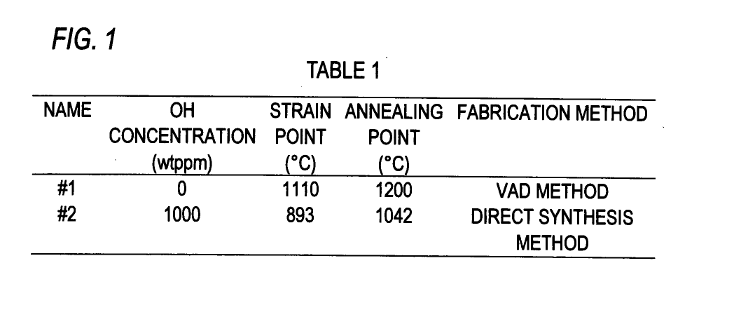

Table 1 shown in FIG. 1 indicates specifications of samples used in an investigation experiment to implement the present invention. The OH concentration was determined according to the method disclosed in Reference literature 1. The synthetic silica glass samples #1 and #2 are fabricated in different production processes and therefore have different OH concentrations and different glass characteristic temperatures (strain point and annealing point). The values of the strain point and the annealing point are shown in a printed material from the manufacturer of the samples. To form a calibration line, four samples of #1 were cut from one glass ingot, four samples of #2 were cut from another glass ingot, and each sample has a size of 60 mm×60 mm×15 mm. The four samples cut from the same ingot have the same composition.

The samples shown in Table 1 were subjected to a heat treatment in the atmosphere with a high temperature electric furnace. First, to eliminate the thermal history of the samples, each sample was heated to a temperature about 50° C. higher than the annealing point and then held at the temperature for 5 hours (in the following, “hour” will be represented by “h”). Then, the temperature was decreased to a desired heat-treatment temperature T_{A} at a temperature decreasing rate of 5 to 10° C./h, the samples were held at the temperature for a long time to allow for the structural relaxation time of the samples, and then, the samples were cooled in the furnace by turning off the heater. In order to narrow the distribution of the fictive temperature during the heat treatment, each sample was sandwiched between two fused silica glass plates having a size of 70 mm×70 mm×10 mm in the furnace. The four samples of #1 were held at 1050° C., 1100° C., 1150° C. and 1200° C., respectively, and the four samples of #2 were held at 900° C., 1000° C., 1050° C. and 1100° C., respectively.

After the heat treatment, the samples were reformed to be 50 mm×35 mm×10 mm, and the both surfaces having a size of 50 mm×35 mm were optically polished.

The LSAW velocity of the fabricated samples was measured with a line-focus-beam ultrasonic material characterization (LFB-UMC) system at an ultrasonic frequency of 225 MHz. The principle and method of measuring the LSAW velocity is described in detail in Reference literatures 2 and 3. In addition, with a plane-wave ultrasonic material characterization (PW-UMC) system, the longitudinal wave velocity and the shear wave velocity were measured at ultrasonic frequencies of 50 to 250 MHz. The principle and method of measuring the longitudinal wave velocity and the shear wave velocity are described in detail in Reference literature 4. Furthermore, the density ρ was measured according to the Archimedes principle. The measurement was performed based on Reference literature 5. The LSAW velocity measured with the LFB-UMC system varies with the measuring system (the LFB ultrasonic device, in particular) and the measurement frequency, and therefore, the system was calibrated with a standard sample whose longitudinal wave velocity, shear wave velocity and density had already been measured (Reference literature 6).

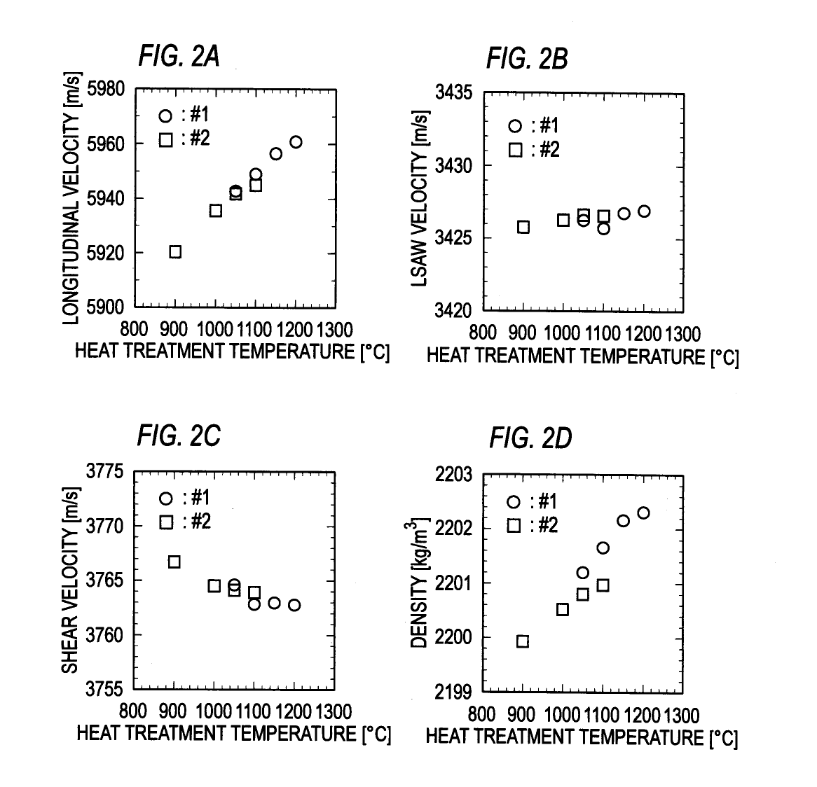

FIGS. 2A to 2D show four relationships between the heat treatment temperature (holding temperature) T_{A} and acoustic properties for each of the synthetic silica glass samples of #1 and #2. For all the samples, the relationship between the heat treatment temperature and each acoustic property was linear at temperatures of about 50° C. lower than the annealing point (see FIG. 1) but deviated from the linearity at temperatures higher than that temperature. This is because, as the heat treatment temperature becomes higher, the structural relaxation time becomes shorter, and the fictive temperature becomes lower than the heat treatment temperature during cooling of the samples. In addition, if the samples were cooled in a sufficiently short time compared with the structural relaxation time, the fictive temperature becomes equal to the heat treatment temperature. The results in FIGS. 2A to 2D show that the longitudinal wave velocity varied most significantly with the heat treatment temperature T_{A}.

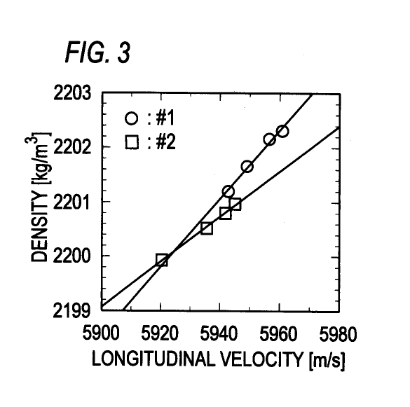

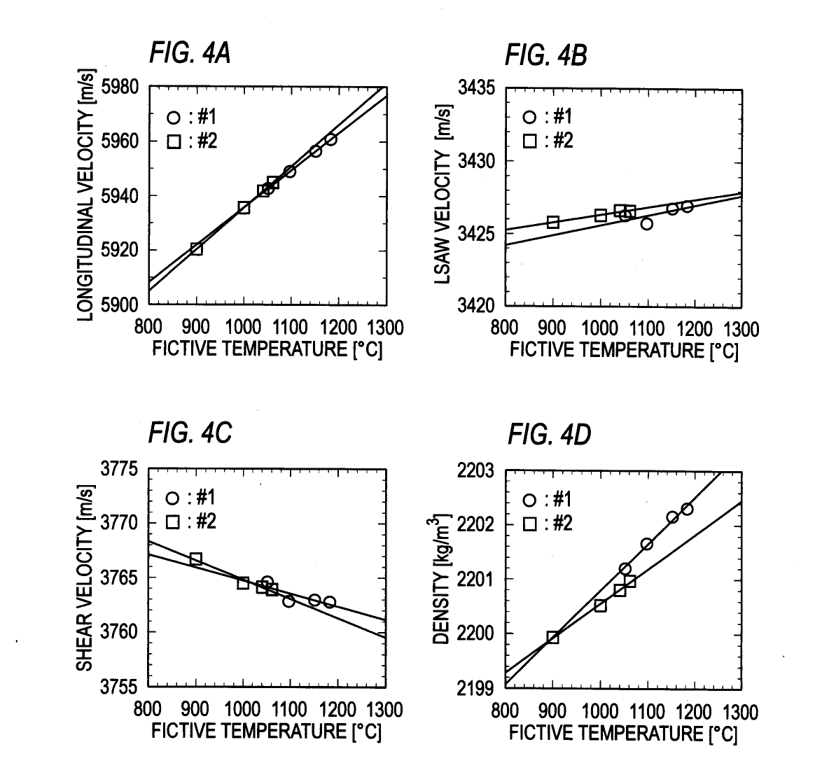

As reported in Non-patent literature 3, there is a linear relationship between the fictive temperature and the density of the synthetic silica glass. FIG. 3 shows a relationship between the density and the longitudinal wave velocity, which varies most significantly with the heat treatment temperature. For both the synthetic silica glasses of #1 and #2, there was a linear relationship between the longitudinal wave velocity and the density. This result shows that the longitudinal wave velocity varies reflecting the fictive temperature. In the light of this fact, for the data of the longitudinal wave velocity an approximate straight line in a temperature range where the fictive temperature can be regarded as being equal to the heat treatment temperature was determined by the least square method, the heat treatment temperature for each sample shown in FIG. 2A was corrected to lie on the approximate straight line at the point of the corresponding longitudinal wave velocity, and the corrected temperature was plotted as the fictive temperature on the approximate straight line as shown in FIG. 4A. That is, the two approximate straight lines were determined from the data shown in FIG. 2A excluding the data for the sample of #1 at the heat treatment temperature of 1200° C. and for the samples of #2 at the heat treatment temperatures of 1050° C. and 1100° C. And the fictive temperature was determined as shown in FIG. 4A by determining the heat treatment temperature of the samples corrected with the approximate straight lines by plotting the longitudinal wave velocities of the four samples of #1 and the longitudinal wave velocities of the four samples of #2 shown in FIG. 2A on the two approximate straight lines. Furthermore, plots of the LSAW velocity shown in FIG. 2B, the shear wave velocity shown in FIG. 2C and the density shown in FIG. 2D on the assumption that the heat treatment temperature for each sample corrected with the approximate straight lines is the fictive temperature, and approximate straight lines of the plots are shown in FIGS. 4B, 4C and 4d, respectively. These drawings show that all the properties have a high linearity.

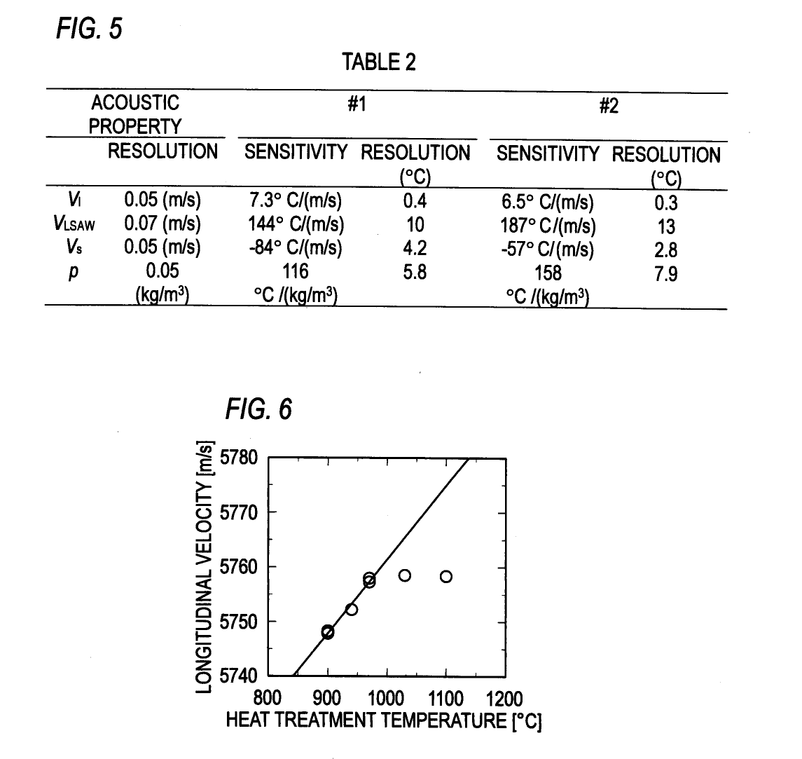

Table 2 in FIG. 5 shows the sensitivity and the resolution of the acoustic properties to the fictive temperature. This result shows that the resolution of the longitudinal wave velocity to the fictive temperature is very high, 0.3 to 0.4° C. The fictive temperature was conventionally measured in the infrared spectroscopy or Raman spectroscopy, and the resolution was ±15° C. (Non-patent literature 1) or ±60° C. (Non-patent literature 2), respectively. Thus, the measurement of the fictive temperature based on the longitudinal wave velocity is 40- to 150-times higher in resolution than the conventional methods and is a highly useful method of measuring the fictive temperature.

The slope of the dependence of the acoustic properties on the fictive temperature is due to the difference in OH concentration and differs between the synthetic silica glasses of #1 and #2 as shown in FIG. 4A. Provided that the longitudinal wave velocity is denoted by V_{L}, the fictive temperature T_{f} can be expressed by the following formula according to the result shown in FIG. 4A.

T_{f}=a×V_{L}+b (1)

In this formula, “a” and “b” denote constants determined by the OH concentration of the synthetic silica glass, and the constants a and b of the approximate straight line assume the following values for the data of the samples of #1 and #2 shown in FIG. 4A.

Sample #1: a=7.294, b=−42295

Sample #2: a=6.549, b=−37871

### First Embodiment

As can be seen from the above description, if any one of the longitudinal wave velocity, the LSAW velocity and the shear wave velocity, for example, the longitudinal wave velocity, is adopted as the acoustic property, and the approximate straight line expressed by the formula (1) shown in FIG. 4A is determined for the acoustic property, the fictive temperature T_{f} of synthetic silica glass to be measured having the same composition as the samples of #1 or #2 can be determined from a measurement of the longitudinal wave velocity V_{L} thereof according to the formula (1). Similarly, if approximate straight lines can be determined directly from the data of the LSAW velocity or the shear wave velocity shown in FIG. 2B or 2C on the assumption that the heat treatment temperature is the fictive temperature, the fictive temperature can be calculated from the approximate straight lines from a measurement of the LSAW velocity or the shear wave velocity of synthetic silica glass to be measured having the same composition.

Although the longitudinal wave velocity is advantageous in that it is highly sensitive to the fictive temperature, measurement of the longitudinal wave velocity involves measuring the thickness of the sample and therefore requires polishing of both surfaces of the sample. Furthermore, to measure the in-plane thickness distribution takes time and effort. To the contrary, the LSAW velocity is convenient in that measurement of the LSAW velocity does not require measurement of the thickness of the sample and therefore can be achieved by polishing only one surface of the sample, and the in-plane distribution thereof can be easily measured. However, as can be seen from FIG. 2B, the LSAW velocity is less sensitive to the heat treatment temperature (the slopes of the approximate straight lines are small) and therefore has a disadvantage that the measurement precision of the fictive temperature is low. The shear wave velocity also has a disadvantage that the sensitivity to the fictive temperature is low, as can be seen from FIG. 2C. In the following, a measuring method that overcomes the disadvantage will be described as a second embodiment.

### Second Embodiment

According to the second embodiment, first, for the longitudinal wave velocity, which is sensitive to the fictive temperature, the approximate straight line formula (1) that expresses the relationships between the fictive temperature and the longitudinal wave velocity shown in FIG. 4A is determined. The fictive temperatures of the samples of #1 and #2 plotted on the approximate straight lines are corrected values of the heat treatment temperatures for the samples of #1 and #2 shown in FIG. 2A, and as with FIG. 4A, from FIG. 4B, the following approximate straight line formula is determined that shows the LSAW velocity in FIG. 2B plotted on the assumption that the corrected heat treatment temperature is the fictive temperature as described above.

T_{f}=c×V_{LSAW}+d (2)

In this formula, “c” and “d” denote constants determined by the OH concentration of the synthetic silica glass, and the constants c and d in the formula (2) assume the following values for the samples of #1 and #2.

Sample #1: c=144, d=−4.922×10⁵

Sample #2: c=187, d=−6.395×10⁵

With the approximate straight line formula (2) determined in this way, the fictive temperature T_{f} of the sample to be measured can be calculated from a measurement of the LSAW velocity V_{LSAW} of the sample. In the case of measuring the in-plane distribution of the fictive temperature, the fictive temperature at each point in the plane may be determined from the measurement of the LSAW velocity V_{LSAW} at the point according to the approximate straight line formula (2) expressing the relationships shown in FIG. 4B or may be determined as described below from the measurement of the LSAW velocity at each point using the fictive temperature determined from the measurement of the longitudinal wave velocity at one point in the plane, for example, the central point, according to the formula (1).

The LSAW velocity V_{LSAW}(x, y) at a point (x, y) on the surface of the sample to be measured and the LSAW velocity V_{LSAW-Std} and the longitudinal wave velocity V_{L-Std} of a standard sample are measured, and a precise value T_{f}(V_{L-Std}) of the fictive temperature of the standard sample is determined from the longitudinal wave velocity V_{L-Std} according to the formula (1). In addition, the fictive temperature T_{f}(V_{LSAW-Std}) of the standard sample and the fictive temperature distribution T_{f}{V_{LSAW}(x, y)} in the surface of the sample are determined from the LSAW velocities V_{LSAW-Std} and V_{LSAW}(x, y). Provided that

ΔT_{f}(x,y)=T_{f}{V_{LSAW}(x,y)}−T_{f}(V_{LSAW-Std}) (3)

the fictive temperature T_{f}(x, y) at the point (x, y) on the sample to be measured can be determined according to the following formula.

T_{f}(x,y)=T_{f}(V_{L-Std})+ΔT_{f}(x,y) (4)

Furthermore, calibration using the longitudinal wave velocity of the sample is also possible. The longitudinal wave velocity V_{L-C} and the LSAW velocity V_{LSAW-C} at the center of the sample and the LSAW velocity V_{LSAW}(x, y) at the point (x, y) on the surface of the sample are measured. A precise value T_{f}(V_{L-C}) of the fictive temperature at the center of the sample is determined from the longitudinal wave velocity V_{L-c} according to the formula (1). Furthermore, the fictive temperature T_{f}(V_{LSAW-C}) at the center of the sample and the fictive temperature distribution T_{f}{V_{LSAW}(x, y)} in the plane of the sample are determined from the LSAW velocities V_{LSAW-C} and V_{LSAW}(x, y) according to the formula (2). From these values, provided that

ΔT_{f}(x,y)=T_{f}{V_{LSAW}(x,y)}−T_{f}(V_{LSAW-C}) (5)

the in-plane distribution T_{f}(x, y) of the fictive temperature on the surface of the sample can be determined according to the following formula (6).

T_{f}(x,y)=T_{f}(V_{L-C})×ΔT(x,y) (6)

Similarly, the fictive temperature can also be calculated from the shear wave velocity of the sample to be measured according to the approximate straight line formula that expresses the relationships between the shear wave velocity and the fictive temperature shown in FIG. 4C.

In FIG. 4D, the difference in slope of the density ρ with respect to the fictive temperature T_{f} between the samples of #1 and #2 is due to the difference in OH concentration. For synthetic silica glass having an OH concentration of 0 wtppm or 1000 wtppm, the fictive temperature T_{f} can be determined by substituting a measurement of the longitudinal wave velocity V_{L} or LSAW velocity V_{LSAW} into the formula (1) or (2) involving coefficients, respectively.

In Non-patent literature 5, the dependences of the density ρ and the fictive temperature T_{f} on the OH concentration were investigated. This investigation has revealed that the absolute value of the density varies with the OH concentration but has not led to a recognition that the slope of the density with respect to the fictive temperature varies. Consequently, the measurement error is significant if the fictive temperature is determined from the measurement of the density ρ according to the conventionally known relationship.

In FIGS. 2A-2D, the heat treatment temperature and the acoustic properties are in a linear relationship at temperatures lower than 1150° C. for the samples of #1 and at temperatures lower than 1000° C. for the samples of #2. These temperatures for the samples #1 and #2 are about 50° C. lower than the respective annealing points and about 40° C. and 110° C. higher than the respective strain points. This is because, as the heat treatment temperature becomes higher, the structural relaxation time becomes shorter, and the fictive temperature becomes lower than the heat treatment temperature during cooling of the samples. In addition, according to Reference literature 7, the structural relaxation time can be estimated to be 11 minutes at the temperature of 1150° C. for the sample of #1 and 16 minutes at the temperature of 1000° C. for the sample of #2. Furthermore, the viscosity can be estimated to be 10^{13.5} poise at 1150° C. for the sample of #1 and 10^{13.7} poise at 1000° C. for the sample of #2. These results mean that glass having a narrow fictive temperature distribution can be fabricated by decreasing the heat treatment temperature during the heat treatment in the course of the process of fabricating a glass ingot. At the strain point, the viscosity η is 10^{14.5} poise, and the structural relaxation time is 47 minutes for the sample of #1 and 14 hours for the sample of #2. Accordingly, it is possible to fabricate a large uniform glass ingot by setting the heat treatment temperature to be lower than the strain points for the respective glasses, thereby narrowing the fictive temperature distribution in the ingot that is due to the temperature distribution during cooling after the heat treatment.

FIG. 3 shows that the longitudinal wave velocity and the density are proportional to each other. FIGS. 4B and 4D show that the LSAW velocity and the density are also proportional to each other. The resolution of the longitudinal wave velocity to the density is 0.003 (kg/m³) for the sample of #1 and 0.002 (kg/m³) for the sample of #2, and the resolution of the LSAW velocity to the density is 0.09 (kg/m³) for the sample of #1 and 0.08 (kg/m³) for the sample of #2. Thus, the local density and the density distribution can be measured by measuring the longitudinal wave velocity or the LSAW velocity.

For the synthetic silica glass produced under standard manufacturing conditions, the concentrations of impurities, such as OH and chlorine, and the concentrations of additives, such as F and Ti, are known and can be considered as varying less significantly.

Therefore, in the case of the synthetic silica glass fabricated in the standard fabrication process as described above, the fictive temperature can be determined according to the formula (1) simply by measuring the longitudinal wave velocity of the sample to be measured as described in the first embodiment. In general, the longitudinal wave velocity can be determined from the propagation time of the longitudinal wave propagating in the sample to be measured in the thickness direction and the thickness of the sample to be measured. The resolution of the longitudinal wave velocity to the fictive temperature is high. Although parallel polishing of the top surface and the bottom surface of the sample to be measured is needed to measure the longitudinal wave velocity, the polishing requirements on the sample to be measured can be relaxed by decreasing the measurement ultrasonic frequency (to about 10 MHz or lower), and the measurement can be incorporated into a mass production process.

As described above, although the LSAW velocity is less sensitive to the fictive temperature than the longitudinal wave velocity, the LSAW velocity can be measured by performing calibration using the standard sample if the surface of the sample to be measured is flat. In addition, the LFB device used for the measurement of the LSAW velocity can be easily moved along the sample surface, the two-dimensional distribution, that is, the fictive temperature distribution over the sample surface can be measured. In particular, the measurement of the LSAW velocity can be incorporated an early stage a stable mass production line.

The sensitivity of the shear wave velocity to the fictive temperature is lower than that of the longitudinal wave velocity, and the measuring ultrasonic device needs to be bonded to the sample to be measured in order to measure the shear wave velocity. Accordingly, the shear wave velocity is useful in the research and development but is more difficult to introduce into a mass-production line than the LSAW velocity.

Silica-Titania Glass

In the foregoing, a method of measuring the fictive temperature of the synthetic silica glass has been described as an example. In the following, an application of the measurement principle described above to measurement of the fictive temperature of the silica-titania glass will be briefly described.

The present invention was applied to the TiO₂—SiO₂ ultra-low expansion glass. The commercially available TiO₂—SiO₂ ultra-low expansion glass was subjected to a homogenization processing and then to a heat treatment at temperatures of 900° C. to 1100° C., as with the SiO₂ glass. The TiO₂ concentration of the sample used was measured by the fluorescent X-ray analysis (Reference literature 8) and the resultant concentration was 7.02 to 7.14 wt %. The longitudinal wave velocity of the TiO₂—SiO₂ ultra-low expansion glass depends on the TiO₂ concentration, the fictive temperature and the OH concentration and therefore was corrected to the value at 7.00 wt % according to the relationship between the TiO₂ concentration and the longitudinal wave velocity (Reference literature 9). FIG. 6 shows a relationship between the heat treatment temperature and the longitudinal wave velocity at 7.00 wt %. In the case of the TiO₂—SiO₂ ultra-low expansion glass, the constants a and b in the formula (1) are determined as follows.

a=7.388, b=−41567

[Flowchart of Fictive Temperature Measurement]

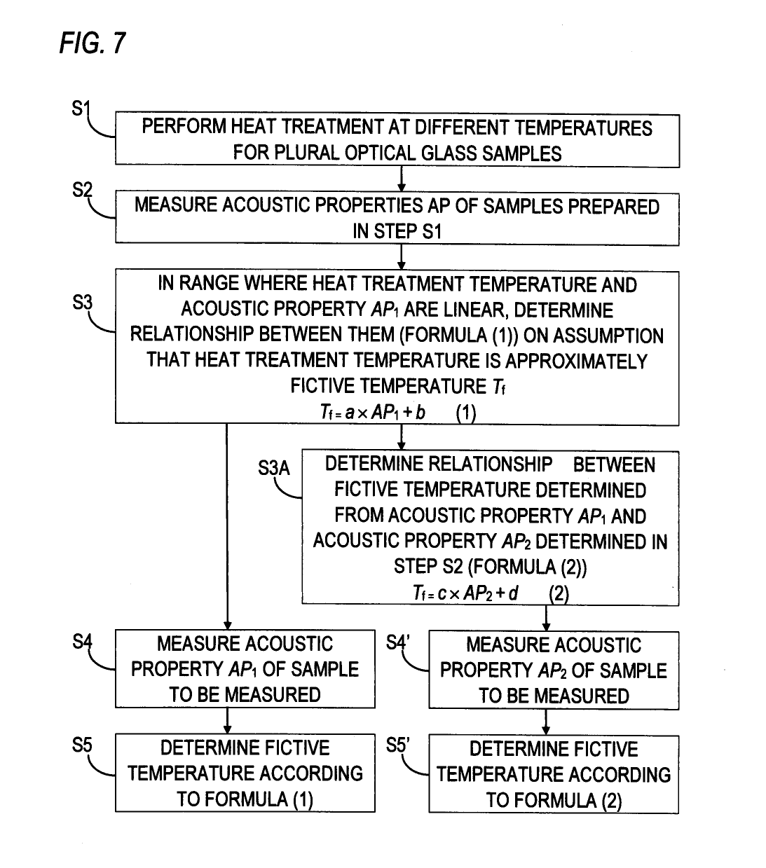

In the following, based on the first and second embodiments described above, a basic procedure of evaluating the fictive temperature of the synthetic silica glass according to the present invention will be described with reference to the flowchart shown in FIG. 7.

### Case of First Embodiment

Step S1: A heat treatment is performed at different temperatures for a plurality of synthetic silica glass samples having the same composition as the sample to be measured to produce calibration-line forming samples having different fictive temperatures.
Step S2: As an acoustic property AP₁, any one of the longitudinal wave velocity, the LSAW velocity and the shear wave velocity for the plurality of calibration-line forming samples produced in Step S1 is measured.
Step S3: From the result of the measurement in Step S2, the relationship between the fictive temperature and the acoustic property AP₁ is determined in the form of an approximate straight line formula, provided that the heat treatment temperature T_{A} is the fictive temperature T_{f} in the range where there is a linear relationship between the heat treatment temperature T_{A} and the acoustic property AP₁. In the case where the longitudinal wave velocity V_{L} is used as the acoustic property AP₁, the formula (1) results.
Step S4: The acoustic property AP₁ of the sample to be measured is measured.
Step S5: The fictive temperature is calculated by substituting the measured acoustic property AP₁ into the approximate straight line formula.

### Case of Second Embodiment

Steps S1, S2 and S3 are the same as those in the case of the first embodiment except that, in Step S2, another one of the longitudinal wave velocity, the LSAW velocity and the shear wave velocity is measured as an acoustic property AP₂ in addition to the acoustic property AP₁. The procedure from Step S3 is as follows.
Step S3A: Another approximate straight line formula that expresses a relationship between the fictive temperature T_{f} determined from the acoustic property AP₁ in Step S3 and the acoustic property AP₂ measured in Step S2 is determined. In the case where the LSAW velocity is used as the acoustic property AP₂, the formula (2) results.
Step S4′: The acoustic property AP₂ of the sample to be measured is measured.
Step S5′: The fictive temperature is determined from the measured acoustic property AP₂ according to the approximate straight line formula determined in Step S3A.

If the approximate straight line formula (1) or (2) for the calibration-line forming samples fabricated under the same conditions as the sample to be measured is known in advance, the fictive temperature can be determined in Steps S4 and S5 or Steps S4′ and S5′.

### INDUSTRIAL APPLICABILITY

According to the present invention, the fictive temperature and the distribution of the fictive temperature of optical glass can be determined with higher precision than conventional and, therefore, glass manufacturers can evaluate the fictive temperature of the fabricated glass, the distribution of the fictive temperature, and the glass fabrication process. The result of the evaluation can be used to improve process conditions for fabricating glass having the fictive temperature and the distribution thereof controlled so as to have desired properties (optical properties, for example).
[Reference Literature 1] K. M. Davis, A. Agarwal, M. Tomozawa, and K. Hirao, “Quantitative infrared spectroscopic measurement of hydroxyl concentrations in silica glass,” J. Non-Cryst. Solids, Vol. 203, pp. 27-36 (1996).
[Reference Literature 2] J. Kushibikiand N. Chubachi, “Material characterization by line-focus-beam acoustic microscope,” IEEE Trans. Sonics Ultrason., Vol. SU-32, pp. 189-212 (1985).
[Reference Literature 3] J. Kushibiki, Y. Ono, Y. Ohashi, and M. Arakawa, “Development of the line-focus-beam ultrasonic material characterization system,” IEEE Trans. Ultrason., Ferroelect., Freq. Contr., Vol. 49, pp. 99-113 (2002).
[Reference Literature 4] J. Kushibiki, and M. Arakawa, “Diffraction effects on bulk-wave ultrasonic velocity and attenuation measurements,” J. Acoust. Soc. Am., Vol. 108, pp. 564-573 (2000).
[Reference Literature 5] H. A. Bowman, R. M. Schoonover, and M. W. Jones, “Procedure for high precision density determinations by hydrostatic weighing,” J. Res. Natl. Bur. Stand., Vol. 71C, pp. 179-198 (1967).
[Reference Literature 6] J. Kushibikiand M. Arakawa, “A method for calibrating the line-focus-beam acoustic microscopy system,” IEEE Trans. Ultrason., Ferroelect., Freq. Contr., Vol. 45, pp. 421-430 (1998).
[Reference Literature 7] K. Saito and A. Ikushima, “Structural relaxation enhanced by impurities in silica glasses,” AIP Conf. Proc., pp. 507-512 (1999).
[Reference Literature 8] M. Arakawa, J. Kushibiki, Y. Ohashi, and K. Suzuki, “Accurate calibration line for super-precise coefficient of thermal expansion evaluation technology of TiO₂-doped SiO₂ ultra-low-expansion glass using the line-focus-beam ultrasonic material characterization system,” Jpn. J. Appl. Phys., Vol. 45, pp. 4511-4515 (2006).
[Reference Literature 9] PCT/JP2011/054192

What is claimed is:

1. A method of measuring a fictive temperature of optical glass, comprising:
(1-A) a step of performing a heat treatment at different temperatures for a plurality of calibration-line forming glass samples having a same composition;
(1-B) a step of measuring any one of a longitudinal wave velocity, an LSAW velocity and a shear wave velocity of the samples obtained in said step (1-A) as an acoustic property AP₁;
(1-C) a step of determining an approximate straight line formula:
T_{f}=a×AP₁+b
that expresses a relationship between a fictive temperature and the acoustic property AP₁ measured in said step (1-B) on an assumption that a heat treatment temperature is a fictive temperature, provided that T_{f} denotes the fictive temperature, and a and b denote constants; and
(1-D) a step of measuring the acoustic property AP₁ of an optical glass sample to be measured having the same composition as said calibration-line forming glass samples and determining the fictive temperature T_{f} by calculation according to said approximate straight line formula.

2. A method of measuring a fictive temperature of optical glass, comprising:
(2-A) a step of performing a heat treatment at different temperatures for a plurality of calibration-line forming glass samples having a same composition;
(2-B) a step of measuring any one of a longitudinal wave velocity, an LSAW velocity and a shear wave velocity of the samples obtained in said step (2-A) as a first acoustic property AP₁ and another of the velocities as a second acoustic property AP₂;
(2-C) a step of determining a first approximate straight line formula:
T_{f}=a×AP₁+b
that approximates a relationship between a fictive temperature and said first acoustic property AP₁ on an assumption that a heat treatment temperature is a fictive temperature, provided that T_{f} denotes the fictive temperature, and a and b denote constants;
(2-D) a step of determining a second approximate straight line formula:
T_{f}=c×AP₂+d
that expresses a relationship between the fictive temperature T_{f} determined in said step (2-C) and said second acoustic property AP₂, provided that c and d denote constants; and
(2-E) a step of measuring the second acoustic property AP₂ of an optical glass sample to be measured having the same composition as said calibration-line forming glass samples and determining the fictive temperature T_{f} from the measured second acoustic property AP₂ according to said second approximate straight line formula.

3. The method of measuring a fictive temperature of optical glass according to claim 1,
wherein said acoustic property AP₁ is the longitudinal wave velocity, and said step (1-D) includes a sub-step of determining an in-plane distribution of the fictive temperature by measuring the longitudinal wave velocity at two or more points on a surface of said sample to be measured.

4. The method of measuring a fictive temperature of optical glass according to claim 2,
Wherein in said step (2-B), the longitudinal wave velocity is measured as said first acoustic property AP₁, the LSAW velocity is measured as said second acoustic property AP₂, and said step (2-E) includes a sub-step of determining a precise value of the fictive temperature by measuring the longitudinal wave velocity of said glass sample to be measured and determining an in-plane distribution of the fictive temperature by measuring the LSAW velocity at a plurality of points on a surface of the sample.

5. The method measuring a fictive temperature of optical glass according to any one of claims 1 to 4,
wherein the optical glass is synthetic silica glass having an OH concentration of 0 to 2000 [wtppm] and a metal impurity concentration of 10 [wtppm] or lower.

6. A method of measuring a fictive temperature of optical glass, comprising:
(3-A) a step of measuring any one of a longitudinal wave velocity, an LSAW velocity and a shear wave velocity of a sample to be measured made of the optical glass as an acoustic property AP; and
(3-B) a step of determining a fictive temperature T_{f} from said measured acoustic property AP according to an approximate straight line formula of the fictive temperature with respect to the acoustic property AP previously determined for calibration-line forming glass samples having the same composition as the sample to be measured.
